(19) United States
(12) Patent Application Publication
(10) Pub. No.: US 2017/0025213 A1
(43) Pub. Date: Jan. 26, 2017

(54) TAKE-UP DEVICE FOR THE TAKE-UP OF INSULATING FLUID AND HOUSING HAVING THE TAKE-UP DEVICE

(71) Applicant: SIEMENS AKTIENGESELLSCHAFT, MUENCHEN (DE)

(72) Inventors: ANDREAS REISING, ZIRNDORF (DE); OLIVER RUDOLPH, SCHWABACH (DE)

(21) Appl. No.: 15/217,017

(22) Filed: Jul. 22, 2016

(30) Foreign Application Priority Data
Jul. 22, 2015 (EP) 15177887.5

(51) Int. Cl. H01F 27/02; H01F 27/20

(52) U.S. Cl. CPC H01F 27/025; H01F 27/20

(57) ABSTRACT

A take-up device for the taking-up of insulating fluid from a tank of a transformer or a reactance coil. The take-up device has a compensator, which is configured as a hollow body with a variable compensator volume, and is connectable to a tank opening of the tank, such that insulating fluid can flow through the tank opening between the interior of the tank and the compensator volume.

### CROSS-REFERENCE TO RELATED APPLICATION

This application claims the priority, under 35 U.S.C. §119, of European application EP 15177887.5, filed Jul. 22, 2015; the prior application is herewith incorporated by reference in its entirety.

### BACKGROUND OF THE INVENTION

### Field of the Invention

The invention relates to a take-up device for the take-up of insulating fluid from a tank of a transformer or a reactance coil, and to a housing of a transformer or a reactance coil.

The housings of transformers and reactance coils are commonly filled with a special insulating fluid, for example insulating oil or transformer oil, the function of which is the insulation and/or cooling of the windings of transformers and reactance coils. Specifically, temperature variations during the operation of transformers and reactance coils cause changes in the volume of the insulating fluid in the housing, which must be compensated. For the compensation of variations in volume of this type, expansion tanks are commonly used which, in the event of an increase in volume of the insulating fluid, take up a variable quantity of fluid, which is then discharged upon the subsequent decrease in volume.

Known expansion tanks are configured for the take-up of a variable quantity of fluid and, in addition to the insulating fluid, for the exchange of air with the environment of the housing (“breathing”), such that the air intake volume occupies the space in the expansion tank which is not filled with insulating fluid, thereby ensuring pressure equalization. Air in the expansion tank is stored for example in a rubber bag, or is separated from the insulating fluid by an elastic membrane, in order to prevent the transfer of oxygen and moisture from the air into the insulating fluid, thus resulting in the more rapid ageing and the impairment of the insulating properties of the insulating fluid, and of other insulating materials in the housing, such as insulating paper. However, expansion tanks of this type do not provide a perfect (hermetic) seal of the housing against the ambient air, as a certain quantity of atmospheric oxygen and moisture invariably enters the insulating fluid through the skin of a rubber bag or through a membrane, thus resulting in the gradual impairment of the insulating fluid.

In rare cases, the impairment of insulation can result in the generation of an arc in the interior of the fluid-filled housing. The resulting extreme heat causes the abrupt vaporization of insulating fluid in the vicinity of the arc. The resulting substantial increase in volume causes a sudden rise in pressure in the interior of the housing. A potential consequence of this pressure increase is the failure of the housing which, under the least favorable circumstances, results in a fire. In order to accommodate the loads resulting from this high pressure, structural measures and the installation of additional equipment are required. To this end, for example, a pressure-relief valve is employed, which opens in response to an overpressure in order to permit the escape of gas and insulating fluid from the housing, or the housing is connected to a decompression chamber by a flange incorporating a rupture disk, such that the rupture disk fails in response to an overpressure, thus permitting the take-up of gas and insulating fluid by the decompression chamber.

### SUMMARY OF THE INVENTION

The object of the invention is the proposal of an improved take-up device for the take-up of insulating fluid from a tank of a transformer or a reactance coil, and an improved housing of a transformer or a reactance coil.

A take-up device according to the invention for the take-up of insulating fluid from a tank of a transformer or a reactance coil contains a compensator, which is configured as a hollow body with a variable compensator volume, and is connectable to a tank opening of the tank, such that insulating fluid can flow through the tank opening between the interior of the tank and the compensator volume.

Here and hereinafter, the term “tank” is applied in the general sense of an insulating fluid-filled container, and thus includes, for example, cable terminal boxes and switchgear chambers which are filled with insulating fluid.

The compensator thus replaces a conventional expansion tank for the compensation of variations in the volume of the insulating fluid. Conversely to a conventional expansion tank with a rubber bag or a membrane, the volume for the take-up of insulating fluid is not adapted to the quantity of insulating fluid to be taken up by the intake or discharge of air, but by the adjustment of the compensator volume itself. By this arrangement, the compensator can be hermetically sealed from the ambient air, such that the insulating fluid is not impaired by oxygen and moisture from the ambient air.

Moreover, a compensator can be provided with a relatively large cross-sectional area, thus permitting connection to the tank interior by a correspondingly large tank opening, whereas a conventional expansion tank is connected to the tank interior by a pipe with a comparatively small cross-sectional area. The large cross-sectional area and the large tank opening permit a rapid response for the compensation of variations in the volume of insulating fluid. By this arrangement, abrupt changes in the volume of insulating fluid and the resulting pressure increases, specifically associated with arcing in the tank interior, can be more rapidly and more effectively offset than in a conventional expansion tank.

In one embodiment, the invention provides a retention and release device which prevents an increase in the compensator volume, provided that an internal pressure in the compensator does not exceed a threshold pressure value, and which permits an increase in the compensator volume, if the internal pressure in the compensator exceeds the threshold pressure value.

This embodiment of the invention is specifically configured for the compensation of an abrupt pressure increase in the tank associated with arcing in the tank. By means of a retention and release device, an increase in the compensator volume is only permitted in the event of an overshoot of a threshold pressure value, which corresponds to an anticipated overpressure in the tank in the event of arcing. In rated operation, during which the tank pressure does not exceed the threshold pressure value, the compensator has no function.

In an alternative embodiment of the invention, a displacement container is provided which, according to preference, can be arranged in the interior of the compensator and hermetically sealed in relation to the compensator, or is connectable to the tank opening in place of the compensator, such that insulating fluid can flow through the tank opening between the tank interior and the interior of the displacement container. The displacement container is preferably configured as an expansion tank for the take-up of insulating fluid from the tank interior through the tank opening.

These embodiments of the invention take account of the fact that, in the event of malfunctions involving the loss of functional capability of the compensator, for example as a result of damage, restoration of the functional capability of the take-up device by the repair or replacement of the compensator, thus permitting the restoration to service of the transformer or reactance coil, is time-consuming and/or cost-intensive, under certain circumstances. In order to overcome this problem, the above-mentioned embodiments of the invention provide for the extension of the take-up device to incorporate a displacement container which, according to preference, can be is connectable on the interior of the compensator, or is connectable to the tank opening in place of the compensator, and is preferably configured as an expansion tank. Advantageously, this enables the compensator, in the event of malfunctions which prevent its functional capability, to be replaced by the displacement container, such that insulating fluid is taken up by the displacement container rather than by the compensator, thereby permitting the continuing operation of the transformer or the reactance coil without the compensator. Specifically, if the displacement container is configured as an expansion tank, any time interval to the repair or replacement of the compensator can be spanned, without the prolonged interruption of the operation of the transformer or reactance coil. In such cases, where applicable, the repair or replacement of the compensator can be omitted altogether, if the continuing long-term operation of the transformer or reactance coil with the displacement container in place of the compensator is acceptable.

Preferably, a gas container with a variable gas container volume is arranged in this case in the displacement container, and the displacement container is provided with a closeable gas opening which communicates with the gas container volume such that, when the gas opening is open, gas can flow between the gas container volume and the tank environment, if the displacement container is connected to the tank opening. The gas container is configured in this case, for example, as a rubber bag.

The gas container thus permits an advantageous pressure equalization upon the infeed of insulating fluid to the displacement container or the discharge of insulating fluid from the displacement container, associated with the “breathing” of the displacement container, by means of the gas container, via the gas opening. The facility for the closure of the gas opening permits the prevention of the entry of insulating fluid into the gas container, when the displacement container is arranged in the compensator and the compensator closes the tank opening. The design of the gas container as a rubber bag is a simple and proven configuration of the gas container for the take-up of a variable gas volume.

The gas opening is also provided, for example, with a gas dehumidifier connection for a gas dehumidifier, or the gas opening is closed by a semi-permeable membrane, which is permeable to gas, but not to liquid.

Accordingly, gas entering the gas container can be advantageously dehumidified, such that less moisture can be transferred from gas contained in the gas container to the insulating fluid.

Moreover, the displacement container is preferably provided with a Buchholz relay connection for a Buchholz relay.

Accordingly, the operation of a transformer or a reactance coil during the use of the displacement container for the compensation of variations in the volume of insulating fluid can be protected by a Buchholz relay.

In a further embodiment of the invention, the displacement container is provided with a vacuum-tight configuration.

The displacement container is thus advantageously protected against damage associated with a low pressure. In a further embodiment of the invention, the displacement container is configured as a cup-type hollow body.

The cup-type design of the displacement container advantageously permits the employment of the interior of the displacement container as a stowage space for the storage of replacement and reserve components, including insulating elements, a replacement rubber bag, a replacement Buchholz relay, rupture disks and/or pressure-relief valves, where the displacement container is arranged in the compensator.

In a further embodiment of the invention, the displacement container is manufactured from a metallic material.

The manufacture of the displacement container from a metallic material advantageously permits a stable design of the displacement container.

In a further embodiment of the invention, the displacement container is provided with a displacement container flange, which is configured for the removable attachment of the displacement container to the tank, optionally closing the tank opening, or to the compensator, optionally closing a compensator opening. To this end, the compensator is preferably provided with a first compensator flange, to which the displacement container flange is removably attached to close the compensator opening. Moreover, the compensator is preferably provided with a second compensator flange, which is configured for the removable attachment of the compensator to the tank, thus closing the tank opening of the tank.

By this arrangement, the displacement container can be optionally removably attached to the tank or to the compensator, and the compensator can be removably attached to the tank, in a simple manner.

In a further embodiment of the invention, the compensator is provided with a bellows for the configuration of the variable compensator volume.

By means of a bellows, a facility for the adaptation of the variable compensator volume of the compensator to a quantity of insulating fluid to be taken up can be advantageously and simply achieved.

In a further development of the above-mentioned embodiment of the invention, at least two compensators are provided, which differ from each other in respect of the hardness grade of their bellows.

The hardness grade of a bellows is understood in this case as a resistance with which a bellows counteracts a change in its length. By the appropriate selection of the hardness grade and the design of the compensators it can be achieved, for example, that at least one compensator primarily offsets thermally-related variations in the volume of insulating fluid, which occur in the normal duty of the transformer or the reactance coil, whereas at least one further compensator, with a higher hardness grade, primarily offsets abrupt variations in the volume of insulating fluid, which are associated with arcing in the tank.

A transformer or reactance coil housing according to the invention contains a tank with a tank opening and a take-up device according to the invention for the take-up of insulating fluid from the tank, with the abovementioned advantages.

Other features which are considered as characteristic for the invention are set forth in the appended claims.

Although the invention is illustrated and described herein as embodied in a take-up device for the take-up of insulating fluid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a first exemplary embodiment of a transformer or reactance coil housing according to the invention;

FIG. 2 is a side view of a second exemplary embodiment of the transformer or reactance coil housing;

FIG. 3 is side view of a third exemplary embodiment of the transformer or reactance coil housing;

FIG. 4 is a schematic sectional view of a fourth exemplary embodiment of the transformer or reactance coil housing in compensator operating mode;

FIG. 5 is a perspective view of the housing represented in FIG. 4, in compensator operating mode;

FIG. 6 is a perspective sectional view of the housing represented in FIG. 4, in the compensator operating mode;

FIG. 7 is a sectional representation of the housing represented in FIG. 4, in expansion tank operating mode;

FIG. 8 is a perspective view of the housing represented in FIG. 4, in the expansion tank operating mode;

FIG. 9 is a perspective sectional view of the housing represented in FIG. 4, in the expansion tank operating mode;

FIG. 10 is a side view of a fifth exemplary embodiment of the transformer or reactance coil housing in rated duty;

FIG. 11 is a side view of the housing represented in FIG. 10, in the event of an overpressure in the housing;

FIG. 12 is a side view of a sixth exemplary embodiment of the transformer or reactance coil housing;

FIG. 13 is a side view of a seventh exemplary embodiment of the transformer or reactance coil housing;

FIG. 14 is a schematic side view of an eighth exemplary embodiment of the transformer or reactance coil housing, in rated duty;

FIG. 15 is a side view of the housing represented in FIG. 14, in the event of an overpressure in the housing; and

FIG. 16 is a side view of a ninth exemplary embodiment of the transformer or reactance coil housing.

### DETAILED DESCRIPTION OF THE INVENTION

In all the figures, mutually corresponding elements are identified by the same reference numbers.

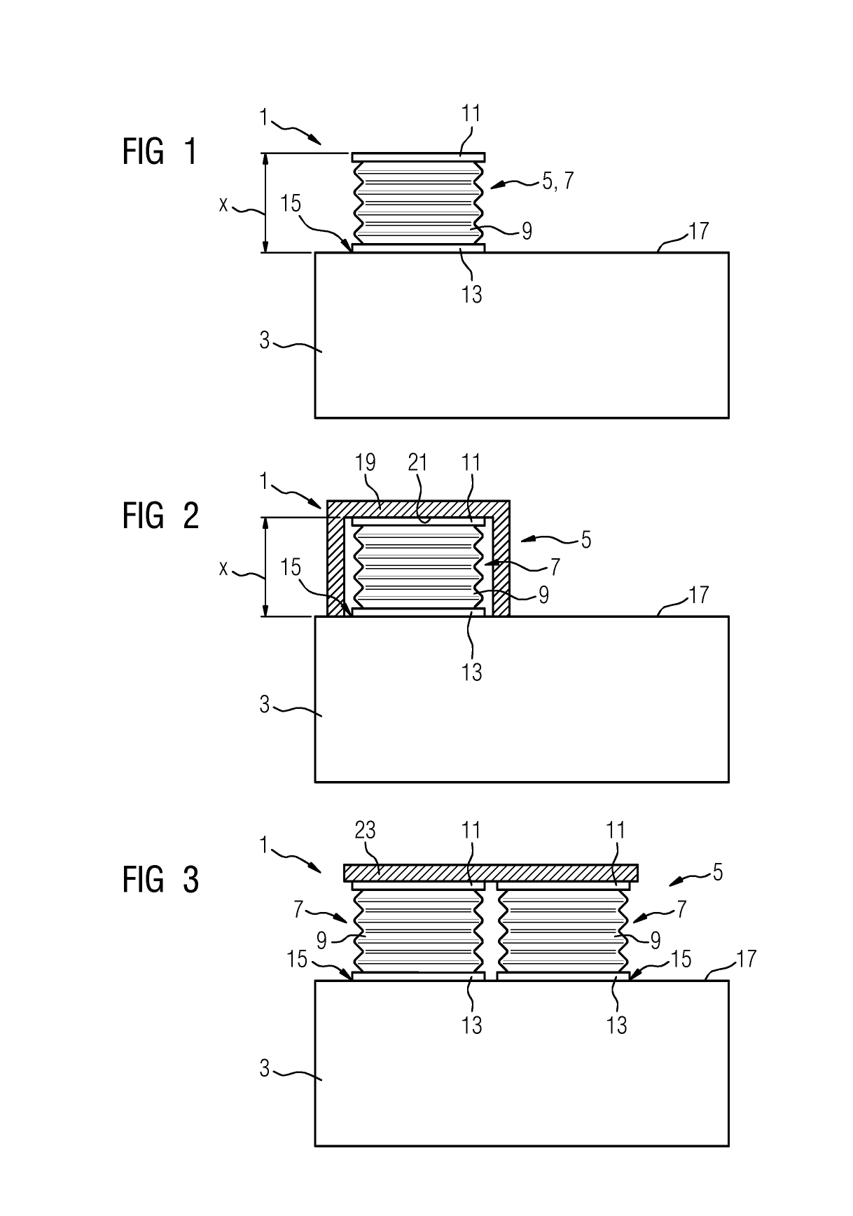

Referring now to the figures of the drawings in detail and first, particularly to FIG. 1 thereof, there is shown a schematic side view of a first exemplary embodiment of a transformer or reactance coil housing 1. The housing 1 contains a tank 3 and a first exemplary embodiment of a take-up device 5 for the take-up of insulating fluid from the tank 3. The take-up device 5 is configured as a compensator 7, which is provided with a bellows 9 and two compensator flanges 11, 13. A first compensator flange 11 is arranged on a first end of the bellows 9, which is outward-facing from the tank 3, and is configured as a blank flange for the occlusion of the compensator 7. The second compensator flange 13 is arranged on a second end of the bellows 9, which is inward-facing to the tank 3, and is configured for the attachment of the compensator 7 to the tank 3, such that a tank opening 15 in the tank 3 is hermetically sealed, and insulating fluid can flow through the tank opening 15 from the tank 3 into the compensator 7, and from the compensator 7 into the tank 3. The tank opening 15 is arranged in a tank cover 17 of the tank 3. The compensator 7 can be removably attached, for example by screw connections, or permanently attached, for example by a welded joint, to the tank 3. In the case of permanent attachment by welding, the second compensator flange 13 can be omitted.

By means of the bellows 9, the compensator 7 delivers variable longitudinal expansion x and an adjustable compensator volume, such that it can take up a variable quantity of insulating fluid. Variations in the volume of insulating fluid in the tank 3 can be compensated accordingly. To this end, the compensator 7 is configured for the compensation at least of thermally-related variations in the volume of insulating fluid which can be anticipated in the normal duty of the transformer or the reactance coil. Moreover, the compensator 7 can additionally be configured for the compensation of abrupt expansions in the insulating fluid associated with arcing in the tank 3, together with the resulting pressure increases in the interior of the tank 3. The design of the compensator 7 is achieved by the corresponding design of a maximum compensator volume, which in turn corresponds to a maximum longitudinal expansion x of the compensator 7.

The bellows 9 is formed, for example, of a metallic material or a rubber.

In place of the direct attachment of the compensator 7 to the tank 3, as represented in FIG. 1, the compensator 7 can also be arranged at a distance from the tank 3, and connected to the tank 3 by a rigid connection, for example a pipe, or a flexible connection, for example a connecting hose, such that insulating fluid can flow from the tank 3 into the compensator 7, and from the compensator 7 into the tank 3. Moreover, rather than by means of the first compensator flange 11, the compensator 7 can also be closed by a vaulted zone of the cover.

FIG. 2 shows a schematic side view of a second exemplary embodiment of THE transformer or reactance coil housing 1. The housing 1 contains the tank 3 and a second exemplary embodiment of the take-up device 5 for the take-up of insulating fluid from the tank 3. This exemplary embodiment only differs from the first exemplary embodiment represented in FIG. 1 in that the take-up device 5 is provided with a compensator frame 19, which is mounted on the tank cover 17 of the tank 3, and contains a limit stop 21 for the first compensator flange 11, such that it limits the maximum longitudinal expansion x of the compensator 7. Consequently, any over-extension of the bellows 9, which is potentially damaging to the bellows 9 and prejudicial to the operational security of the compensator 7, can be advantageously prevented.

FIG. 3 shows a schematic side view of a third exemplary embodiment of the transformer or reactance coil housing 1. The housing 1 contains the tank 3 and a third exemplary embodiment of the take-up device 5 for the take-up of insulating fluid from the tank 3. This exemplary embodiment essentially differs from the first exemplary embodiment represented in FIG. 1 in that the take-up device 5 is provided with two compensators 7, rather than a single compensator 7. Each of the two compensators 7 is configured with the same design principle as the compensator 7 in the first exemplary embodiment represented in FIG. 1.

By the use of a plurality of compensators 7, the compensation of variations in volume of the insulating fluid can be distributed between a plurality of compensators 7, such that the individual compensators 7 require a lower capacity than the compensator 7 in a take-up device 5 with only one compensator 7. Abrupt variations in the volume of insulating fluid associated with arcing also generate local pressure variations, such that it is advantageous to distribute a plurality of compensators 7 over the full extent of the tank, in order to permit the most effective possible compensation of such local variations in pressure and volume.

The use of a plurality of compensators 7 permits further advantageous embodiments of the invention. Equivalent compensators 7, for example as represented in FIG. 3, can be interconnected by a coupling plate 23, which interconnects the first compensator flange 11 of the compensators 7, in order to permit the even distribution of loads on these compensators 7, such that none of these compensators 7 is excessively loaded.

Moreover, compensators 7 can be employed which are mutually different in respect of the hardness grade of their bellows 9. The hardness grade of a bellows 9 is understood as a resistance with which a bellows 9 counteracts a change in its length. For example, at least the first compensator 7 is provided with the bellows 9 with a first hardness grade, and at least a second compensator 7 is provided with the bellows 9 with a second hardness grade, which is greater than the first hardness grade. By the appropriate selection of the hardness grade and the design of the compensators 7 it can be achieved that the first compensators 7 primarily offset thermally-related variations in the volume of insulating fluid, which occur in the normal duty of the transformer or the reactance coil, whereas the second compensators 7 primarily offset abrupt variations in the volume of insulating fluid, which are associated with arcing in the tank 3.

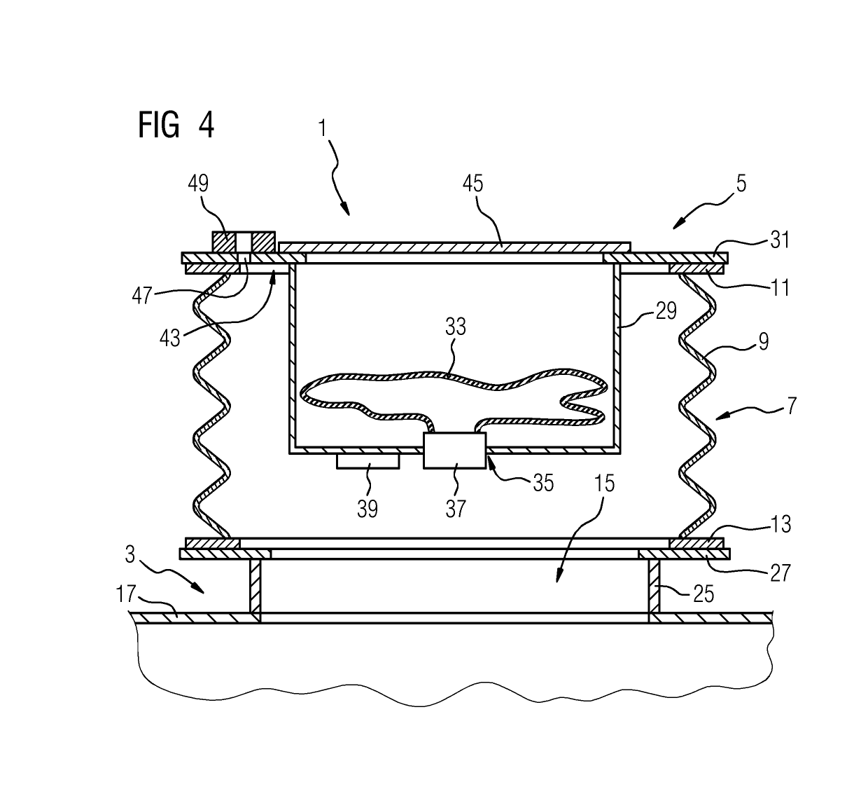

FIGS. 4 to 9 show a fourth exemplary embodiment of the transformer or reactance coil housing 1. The housing 1 contains the tank 3 and a fourth exemplary embodiment of the take-up device 5 for the take-up of insulating fluid from the tank 3.

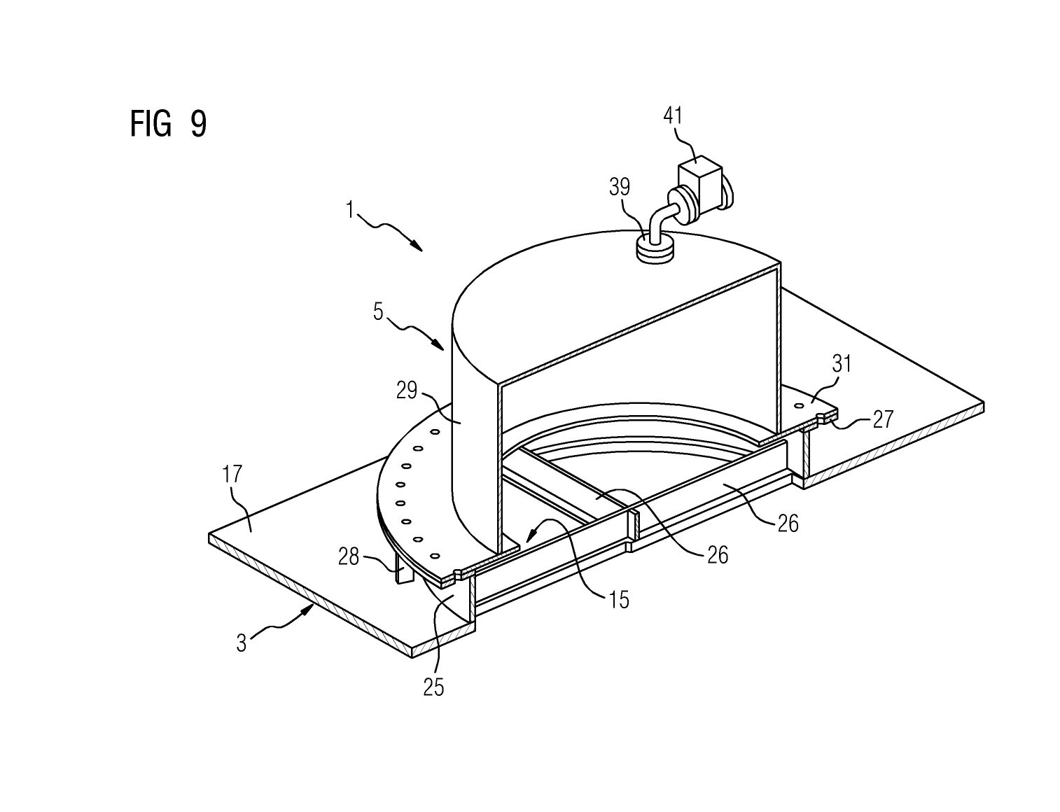

In the tank 3, in FIGS. 4 to 9 respectively, only a section of a tank cover 17 in the area of a tank opening 15 in the tank 3 is represented. The tank opening 15 is surrounded by a tank skirt 25. The tank skirt 25 is provided with a shoulder flange 27 for the attachment of the take-up device 5. Optionally, in the interests of the increased rigidity of the tank skirt 25, different areas of an interior surface of the tank skirt 25 can be interconnected by skirt reinforcement elements 26, for example by skirt reinforcement elements 26 which show a right-angled cruciform structure (see FIG. 9). Moreover, the shoulder flange 27 can optionally be supported on the tank cover 17 by support brackets 28, which extend between the former and the tank cover 17.

The take-up device 5 contains the compensator 7 and a displacement container 29. The take-up device 5 is configured to operate, as preferred, in one of two different operating modes. Hereinafter, a first operating mode is designated as compensator operating mode, and the second operating mode is designated as expansion tank operating mode.

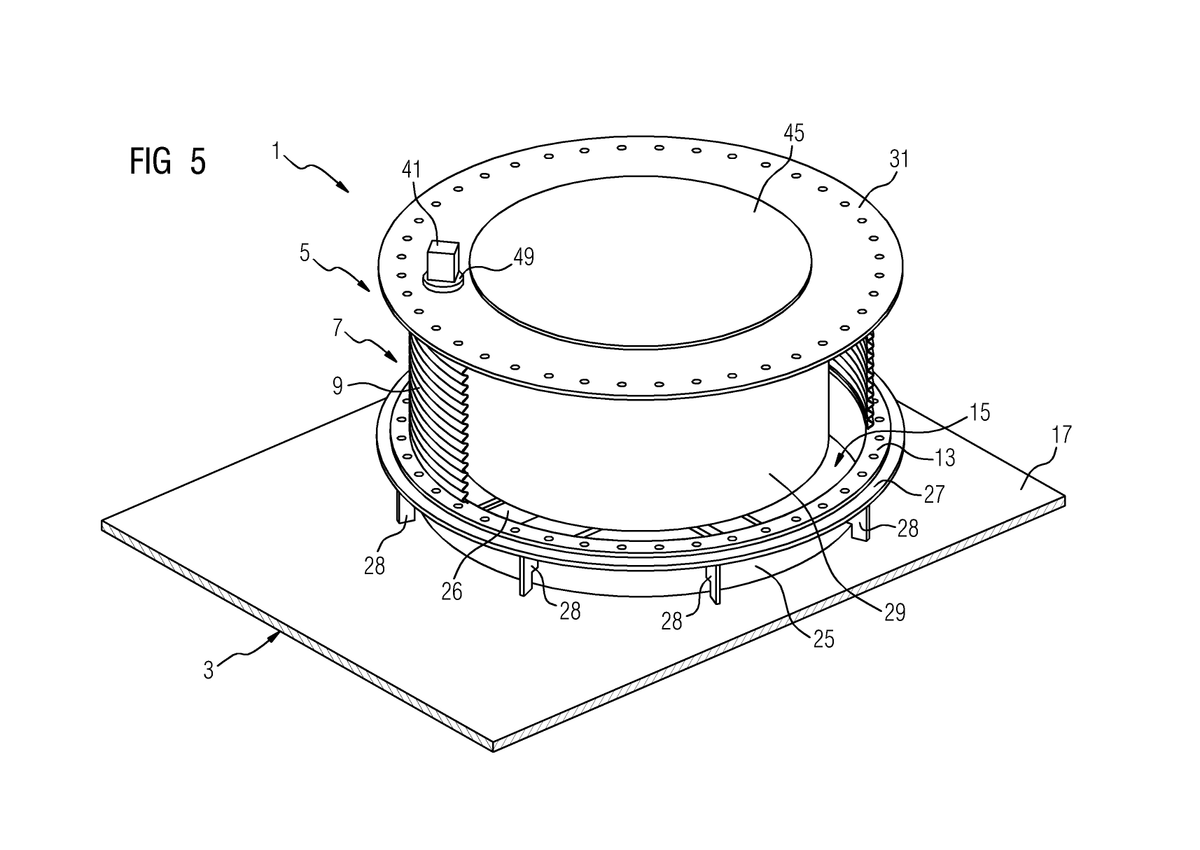

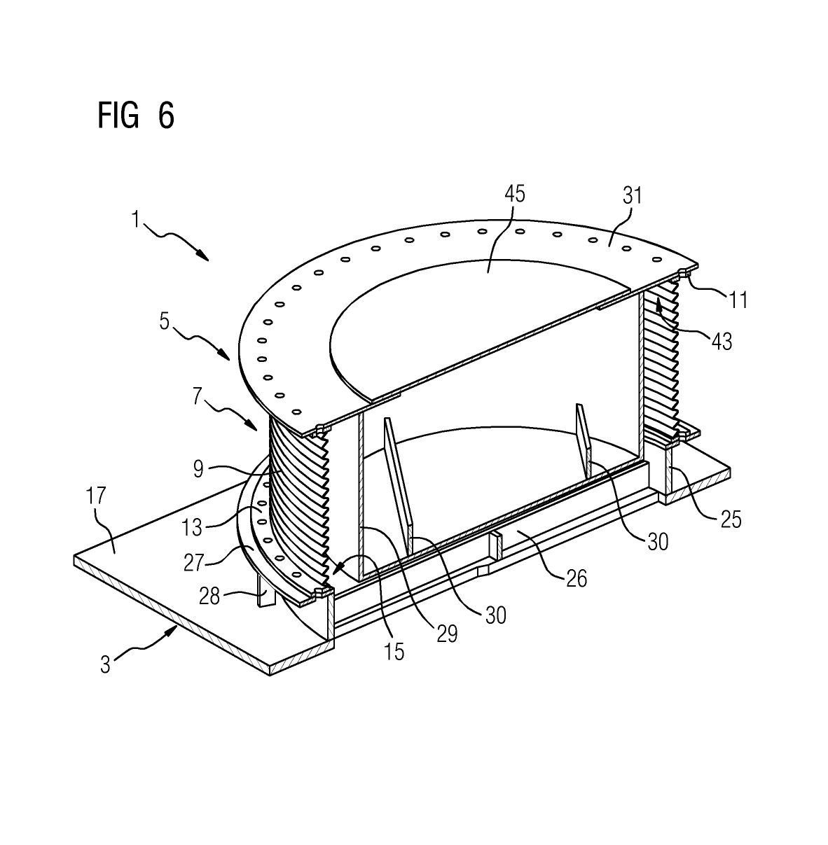

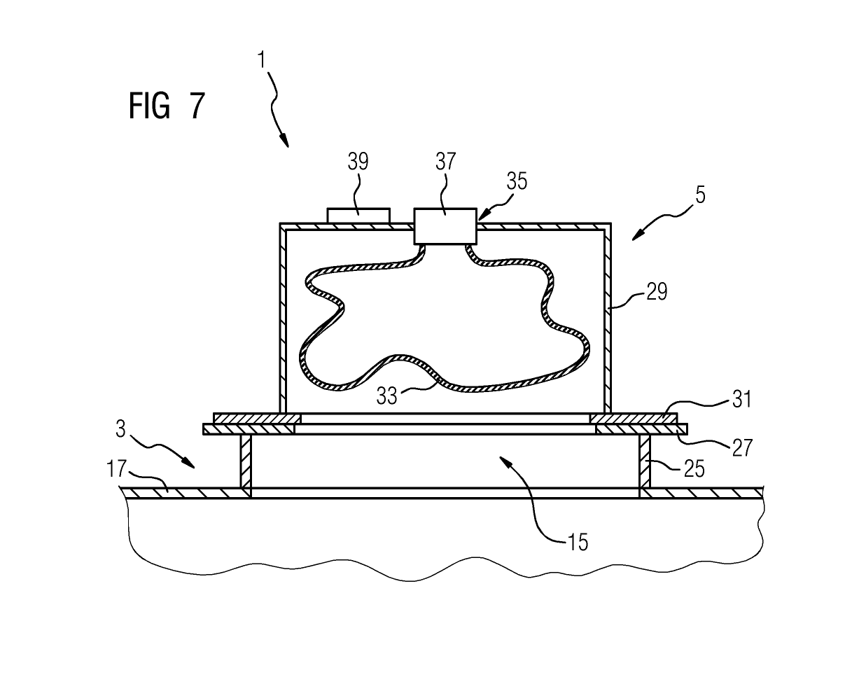

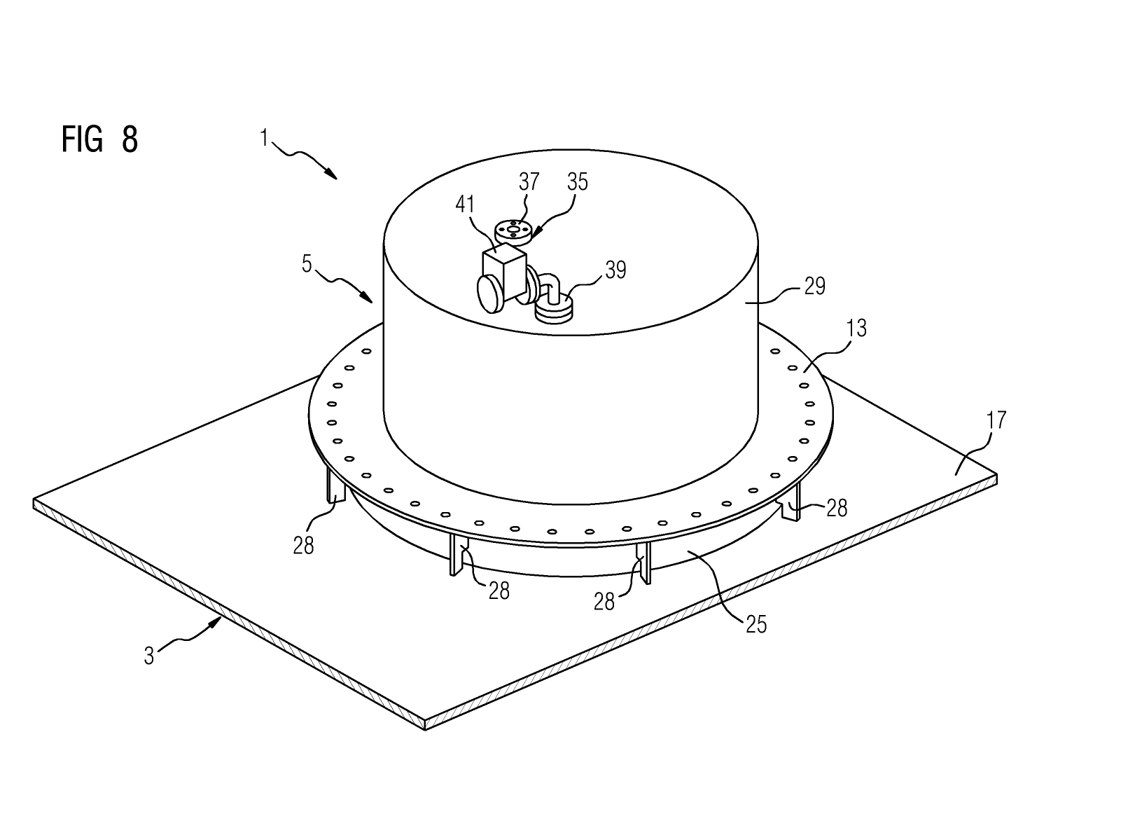

FIGS. 4 to 6 show the take-up device 5 in the compensator operating mode, wherein the bellows 9 of the compensator 7 in FIG. 5 is shown in cut-away, in order to make the compensator interior visible. FIGS. 7 to 9 show the take-up device 5 in the expansion tank operating mode. FIGS. 4 and 7 respectively show a schematic sectional representation of the housing 1, FIGS. 5 and 8 respectively show a perspective representation of the housing 1, and FIGS. 6 and 9 respectively show a perspective sectional representation of the housing

As in the compensators 7 in the exemplary embodiments represented in FIGS. 1 to 3, the compensator 7 contains a bellows 9 which interconnects a first compensator flange 11 and a second compensator flange 13. Conversely to the compensators 7 in the exemplary embodiments represented in FIGS. 1 to 3, both compensator flanges 11, 13 show an annular configuration.

The displacement container 29 is configured as an essentially cylindrical, cup-type and vacuum-tight hollow body, and is manufactured from a metallic material. Alternatively, the displacement container 29 can also be configured as a compensator 7. One edge of the displacement container 29 is configured as a displacement container flange 31.

In the displacement container 29, a gas container 33 with a variable gas container volume is arranged, which is configured as a rubber bag. In its base, the displacement container 29 is provided with a closeable gas opening 35 to the gas container volume. The gas opening 35 is closeable, for example by a slide valve, a valve or a cap plug. Moreover, the gas opening 35 is provided with a gas dehumidifier connection 37 for a gas dehumidifier. In its base, the displacement container 29 is also provided with a closeable Buchholz relay connection 39 for a Buchholz relay 41. Optionally, in the interests of the increased rigidity of the displacement container 29, different areas of an interior surface of the displacement container 29 can be interconnected by bracing elements 30 (see FIG. 6).

In compensator operating mode (see FIGS. 4 to 6), the second compensator flange 13 of the compensator 7 is connected to the shoulder flange 27 of the tank skirt 25, such that the tank opening 15 is hermetically sealed, and insulating fluid can flow through the tank opening 15 from the tank 3 into the compensator 7, in the event of an increase in the volume of insulating fluid, and from the compensator 7 into the tank 3, in the event of a decrease in the volume of insulating fluid. In compensator operating mode, the displacement container 29 is arranged in the compensator 7, wherein the displacement container flange 31 is removably attached to the first compensator flange 11, wherein a surface of the displacement container flange 31 facing the base of the displacement container 29 cooperates with the first compensator flange 11. The gas opening 35 and the Buchholz relay connection 39 of the displacement container 29 are thus closed, such that the displacement container 29 hermetically seals a compensator opening 43 in the compensator 7 which is outward-facing from the tank 3. The displacement container 29 is closed by a closing flange 45, configured as a blank flange, which is connected to the displacement container flange 31 and wherein, in an edge zone, it cooperates with a surface of the displacement container flange 31 facing away from the base. The displacement container flange 31 is also provided with a flange opening 47 which, in compensator operating mode, leads to the compensator volume. Above the flange opening 47, in compensator operating mode, a connecting flange 49 for the connection of a Buchholz relay 41 is mounted on the displacement container flange 31. In compensator operating mode, the interior of the displacement container 29 can advantageously be configured as a stowage space for the storage of replacement and reserve components, including insulating elements, a replacement rubber bag, a replacement Buchholz relay and/or pressure-relief valves.

In expansion tank operating mode (see FIGS. 7 to 9), in place of the compensator 7, the displacement container 29 is secured over the tank opening 15 to the tank 3, such that insulating fluid can flow through the tank opening 15 from the tank 3 into the displacement container 29, in the event of an increase in the volume of insulating fluid, and from the displacement container 29 into the tank 3, in the event of a decrease in the volume of insulating fluid. To this end, the displacement container flange 31 is connected to the shoulder flange 27, such that a surface of the displacement container flange 31 facing away from the base cooperates with the shoulder flange 27. In expansion tank operating mode, the flange opening 47 is closed by the shoulder flange 27. In expansion tank operating mode, the gas opening 35 is opened, thereby permitting the gas container 33 to “breathe”, i.e. gas is able to flow through the gas opening 35 between the housing environment 1 and the gas container volume of the gas container 33. Moreover, in expansion tank operating mode, a gas dehumidifier (not represented) for the dehumidification of the gas flowing through the gas opening 35 into the gas container 33 is connected to the gas dehumidifier connection 37. In expansion tank operating mode, the Buchholz relay connection 39 is also opened, and a Buchholz relay 41 is connected to the Buchholz relay connection 39.

The take-up device 5 is normally operated in compensator operating mode. Expansion tank operating mode is primarily intended for use under problem conditions, in which the functional capability of the compensator 7 is impaired, for example on the grounds of damage to the compensator 7. In order to switch from compensator operating mode to expansion tank operating mode, the compensator 7 is firstly removed from the tank 3, wherein the second compensator flange 13 is released from the shoulder flange 27. Thereafter, the displacement container 29 is separated from the compensator 7, wherein the displacement container flange 31 is released from the first compensator flange 11, the closing flange 45 and the connecting flange 49. Thereafter, the displacement container 29 is secured to the tank 3, wherein the displacement container flange 31 is connected to the shoulder flange 27. Moreover, for expansion chamber operating mode, the gas opening 35 and the Buchholz relay connection 39 are opened, a gas dehumidifier is connected to the gas dehumidifier connection 37, and a Buchholz relay 41 is connected to the Buchholz relay connection 39. In compensator operating mode, the displacement container 29 closes the compensator 7 and displaces insulating fluid from the compensator 7. In expansion tank operating mode, the displacement container 29 functions as a conventional expansion tank.

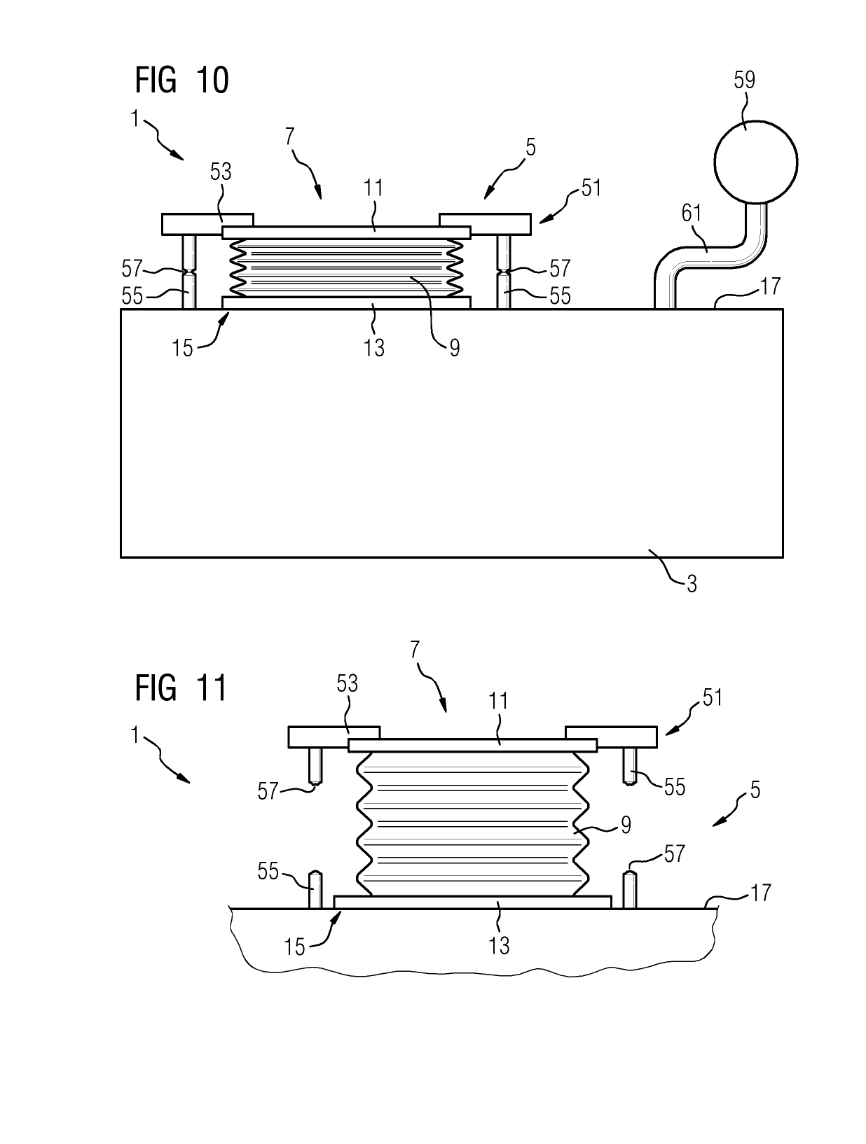

FIGS. 10 to 16 respectively show schematic side views of further exemplary embodiments of the transformer or reactance coil housing 1, wherein the housing 1 respectively contains the tank 3 and the take-up device 5. The take-up device 5 is respectively provided with a compensator 7, which is configured in accordance with the compensator 7 of the exemplary embodiment represented in Fig, 1. In addition to the compensator 7, the take-up device 5 is respectively provided with a retention and release device 51 which prevents the expansion of the bellows 9 of the compensator 7, provided that the internal pressure in the compensator 7 does not exceed a threshold pressure value, and which permits the expansion of the bellows 9, if the internal pressure in the compensator 7 exceeds the threshold pressure value. Essentially, the exemplary embodiments represented in FIGS. 10 to 16 only differ from each other in respect of the configuration of the retention and release device 51.

FIGS. 10 and 11 show an exemplary embodiment, in which the second compensator flange 13 of the compensator 7, as in the exemplary embodiment represented in FIG. 1, is attached to the tank cover 17 for the closure of a tank opening 15. The retention and release device 51 contains at least a retaining element 53, which cooperates with the upper side of the first compensator flange 11, which is configured as a blank flange, and is connected to the tank cover 17 by at least one connecting element 55. Each connecting element 55 is provided with a rupture joint 57, which is designed for the mutual separation of the connecting element 55 at the rupture joint 57, if the internal pressure in the compensator 7 exceeds the threshold pressure value. FIG. 10 shows the housing 1 in rated duty, in which the internal pressure in the compensator 7 does not exceed the threshold pressure value, and the expansion of the bellows 9 is prevented by the retention and release device 51. FIG. 11 shows the retention and release device 51 after the failure of the connecting elements 55 and the expansion of the bellows 9. As the compensator 7, in this exemplary embodiment, is only designed for the compensation of pressure increases generated in the tank 3 by arcing, the housing 1, for the compensation of pressure increases in rated duty, is provided with a conventional expansion tank 59, which is connected to the tank 3 by a connecting pipe 61. Naturally, for the compensation of pressure increases in rated duty, in place of a conventional expansion tank 59, at least one further compensator 7 can also be connected to the tank 3.

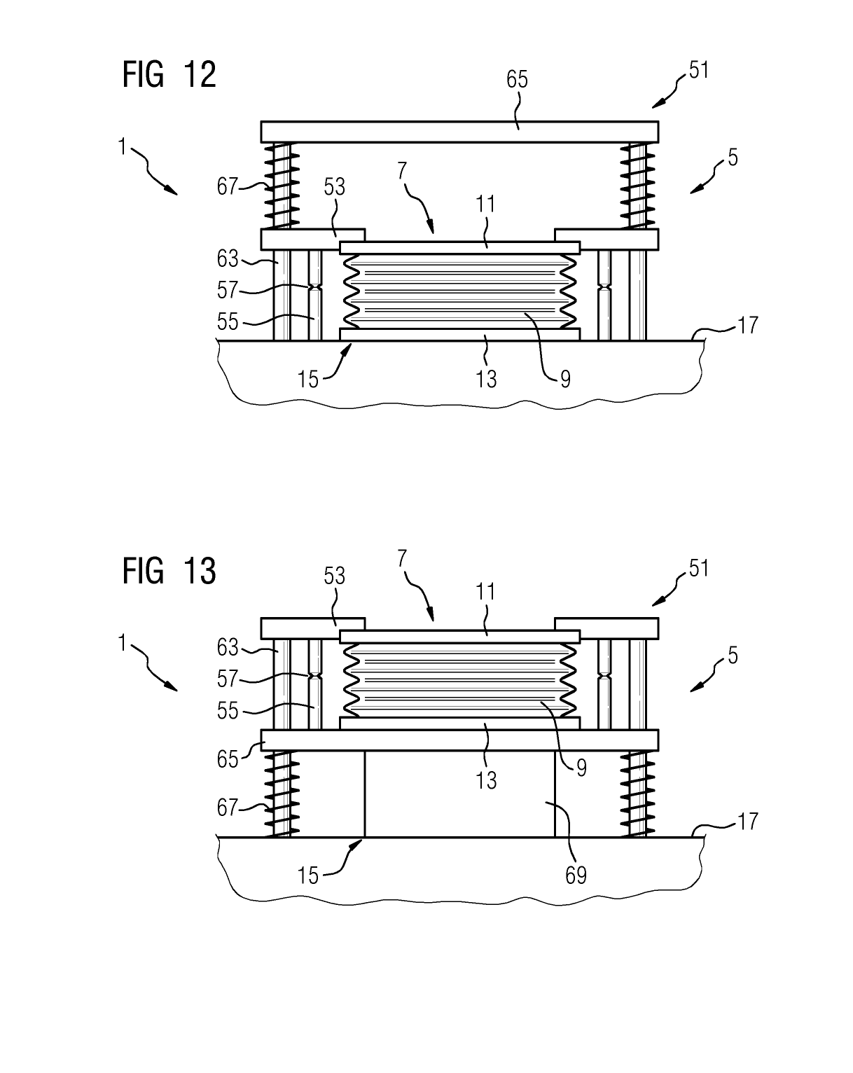

FIG. 12 shows a further development of the exemplary embodiment represented in FIGS. 10 and 11. In this further development, the retention and release device 51 is additionally provided with guide supports 63, arranged around the compensator 7 on the tank cover 17, which are interconnected above the compensator 7 by a support connecting element 65, and each of which carries a retaining element 53. To this end, for example, each guide support 63 is configured as a rod, and is routed through an opening in a retaining element 53. Between the support connecting element 65 and the respective retaining element 53, a damping spring 67 is moreover arranged on each guide support 63, which is compressed by the expansion of the bellows 9 further to the failure of the connecting elements 55, such that the expansion of the bellows 9 is counteracted and damped, in order to reduce any abrupt loading of the anchoring arrangement of the compensator 7, and prevent any over-expansion of the compensator 7.

FIG. 13 shows an alternative to the further development shown in FIG. 12 of the exemplary embodiment represented in FIGS. 10 and 11. Again, in this further development, the retention and release device 51 is additionally provided with guide supports 63, arranged around the compensator 7 on the tank cover 17. Conversely to FIG. 12, each guide support 63 is solidly connected to a retaining element 53, and a plate-type support connecting element 65 is arranged below the compensator 7 on the second compensator flange 13 thereof, such that the compensator 7 cooperates with the support connecting element 65, rather than with the tank cover 17. On the support connecting element 65, a connecting pipe 69 is arranged on the tank side, which extends from the support connecting element 65 to the tank cover 17, where it encloses the tank opening 15 and is arranged for movement relative to the tank cover 17 in the vertical direction. The support connecting element 65 is provided with a connection opening, which connects the interior of the connecting pipe 69 to the interior of the compensator, such that insulating fluid can flow from the tank interior through the connecting pipe 69 to the interior of the compensator. The connecting elements 55 with the rupture joints 57 respectively connect one retaining element 53 to the support connecting element 65. The guide supports 63 direct the support connecting element 65. To this end, for example, each guide support 63 is configured as a rod and is routed through a guide opening in the support connecting element 65. The rupture joints 57 are configured for the mutual separation of the connecting elements 55 at the rupture joints 57, if the internal pressure in the compensator 7 exceeds the threshold pressure value. Further to the failure of the connecting elements 55, the bellows 9 expands downwards by the action of the internal pressure in the compensator 7, such that the movement of the support connecting element 65 on the guide supports 63 is directed towards the tank cover 17, and the connecting pipe 69 is displaced into the interior of the tank. On each guide support 63, between the support connecting element 65 and the tank cover 17, a damping spring 67 is arranged, which is compressed by the expansion of the bellows 9 further to the failure of the connecting elements 55, such that it counteracts the expansion of the bellows 9 and damps the latter.

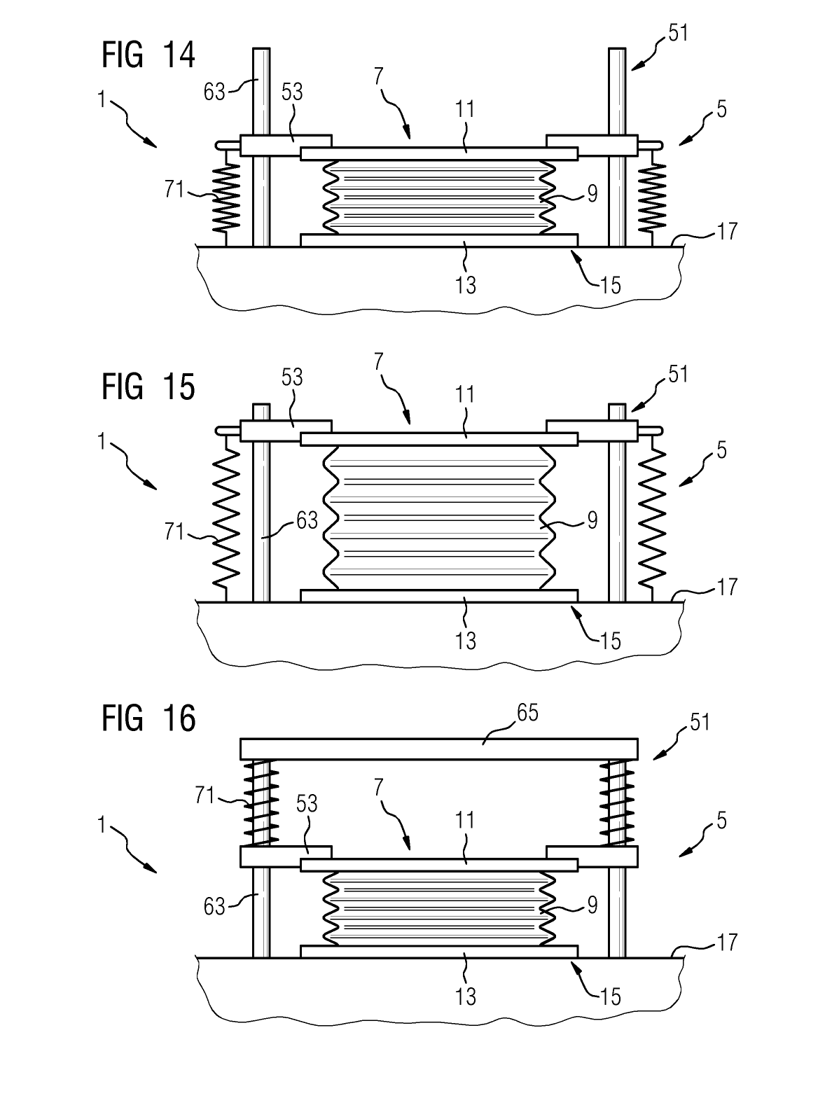

FIGS. 14 and 15 show an exemplary embodiment, in which the second compensator flange 13 of the compensator 7, as in the exemplary embodiment represented in FIG. 1, is attached to the tank cover 17 for the closure of a tank opening 15. The retention and release device 51 contains at least a retaining element 53, which cooperates with the upper side of the first compensator flange 11, which is configured as a blank flange. The retention and release device 51 is additionally provided with guide supports 63, arranged around the compensator 7 on the tank cover 17, each of which carries a retaining element 53. For example, each guide support 63 is configured as a rod and is routed through an opening in a retaining element 53. Between the tank cover 17 and the respective retaining element 53, a pre-tensioned pre-tensioning spring 71 is arranged along each guide support 63. The pre-tensioning of the pre-tensioning springs 71 prevents the expansion of the bellows 9, provided that the internal pressure in the compensator 7 does not exceed a threshold pressure value. This situation is represented in FIG. 14. Further to the overshoot of the threshold pressure value, the bellows 9 expands upwards, as represented in FIG. 15.

FIG. 16 shows a further exemplary embodiment, which only differs from the exemplary embodiment represented in FIGS. 14 and 15 in that the guide supports 63 are interconnected above the compensator 7 by means of a support connecting element 65, and the pre-tensioning springs 71 are arranged respectively above the compensator 7 between the support connecting element 65 and a retaining element 53 on a guide support 63.

Although the invention has been illustrated and described in detail with reference to preferred exemplary embodiments, the invention is not limited by the examples disclosed, and other variations may be inferred by a person skilled in the art, without departing from the scope of protection of the invention. Specifically, the take-up device 5 can be provided with a plurality of compensators 7 of the type represented in FIGS. 4 to 9, each with a displacement container 29 and/or a plurality of compensators 7 according to one or more of the exemplary embodiments represented in FIGS. 10 to 16 can each be provided with a retention and release device 51. The compensators 7 can show different hardness grades, and/or the retention and release devices 51 can be provided with rupture joints 57 which are rated for different threshold pressure values, or with pre-tensioning springs 71 with different spring constants and/or pre-tensions, in order to compensate different pressure increases in the tank 3.

1. A take-up device for taking-up insulating fluid from a tank of a transformer or a reactance coil, the take-up device comprising:
a compensator configured as a hollow body with a variable compensator volume, and is connectable to a tank opening of the tank, such that the insulating fluid can flow through the tank opening between an interior of the tank and the variable compensator volume.

2. The take-up device according to claim 1, further comprising a retention and release device which prevents an increase in the variable compensator volume, provided that an internal pressure in said compensator does not exceed a threshold pressure value, and which permits an increase in the variable compensator volume, if the internal pressure in said compensator exceeds the threshold pressure value.

3. The take-up device according to claim 1, further comprising a displacement container which can be disposed in an interior of said compensator and hermetically sealed in relation to said compensator, or is connectable to the tank opening in place of said compensator, such that the insulating fluid can flow through the tank opening between the interior of the tank and an interior of said displacement container.

4. The take-up device according to claim 3, wherein said displacement container is configured as an expansion tank for a take-up of the insulating fluid from the interior of the tank through the tank opening.

5. The take-up device according to claim 4,
further comprising a gas container with a variable gas container volume disposed in said displacement container; and
wherein said displacement container has a closeable gas opening which communicates with the variable gas container volume such that, when said closesable gas opening is open, gas can flow between said variable gas container volume and the tank environment, if said displacement container is connected to the tank opening.

6. The take-up device according to claim 5, wherein said gas container is configured as a rubber bag.

7. The take-up device according to claim 3, wherein said displacement container is provided with a Buchholz relay connection for a Buchholz relay.

8. The take-up device according to claim 3, wherein said displacement container is configured as a cup-type hollow body.

9. The take-up device according to claim 3, wherein said displacement container is manufactured from a metallic material.

10. The take-up device according to claim 3, wherein said displacement container has a displacement container flange which is configured for a removable attachment of said displacement container to the tank, optionally closing the tank opening, or to said compensator, optionally closing a compensator opening.

11. The take-up device according to claim 10, wherein said compensator has a first compensator flange, to which said displacement container flange is removably attached to close said compensator opening.

12. The take-up device according to claim 11, wherein said compensator is provided with a second compensator flange configured for a removable attachment of said compensator to the tank, thus closing the tank opening of the tank.

13. The take-up device according to claim 1, wherein said compensator has a bellows for configuring the variable compensator volume.

14. The take-up device according to claim 13, wherein said compensator is one of at least two compensators, which differ from each other in respect of a hardness grade of said bellows.

15. A housing of a transformer or a reactance coil, the housing comprising:
a tank with a tank opening formed therein; and
a take-up device for taking-up insulating fluid from said tank, said take-up device containing a compensator configured as a hollow body with a variable compensator volume, and is connected to said tank opening of said tank, such that the insulating fluid can flow through said tank opening between an interior of said tank and the variable compensator volume.
